(19) United States
(12) Patent Application Publication
(10) Pub. No.: US 2018/0161971 A1
(43) Pub. Date: Jun. 14, 2018

(54) MULTIFUNCTIONAL WRENCH STRUCTURE

(71) Applicant: YUN CHAN INDUSTRY CO., LTD., New Taipei City (TW)

(72) Inventor: FU-JUI HSIAO, NEW TAIPEI CITY (TW)

(21) Appl. No.: 15/373,470

(22) Filed: Dec. 9, 2016

(51) Int. Cl. B25F 1/00; B25B 13/46; B67B 7/16

(52) U.S. Cl. CPC B25F 1/00; B67B 7/16; B25B 13/462

(57) ABSTRACT

A multifunctional wrench structure includes a rod body, one end of which is configured with a ratchet member allowing the disassembly and assembly of hexagonal head screws (bolts); a hexagonal member is configured on one end of the rod body far away from the ratchet member allowing the disassembly and assembly of hex socket cap screws; at least one bottle opener member is configured on the rod body between the ratchet member and hexagonal member, and a breach is formed on the bottle opener member, thereby allowing bottle caps to be pulled away. Therefore, the wrench of the present has three different functions combined in one single rod body.

### (a) TECHNICAL FIELD OF THE INVENTION

The present invention relates to a multifunctional wrench structure, and more particularly to a multifunctional wrench structure having the functions of a hexagonal wrench, ratchet socket wrench, and bottle opener.

### (b) DESCRIPTION OF THE PRIOR ART

Wrenches are used for the disassembly and assembly of screws or nuts. Among them, hexagonal wrenches are a hexagonal column structure used to turn hex socket cap screws and always used in the assembly of bicycles or the disassembly and assembly of furniture; a hexagonal wrench has six faces to be in contact with a screw, which is not easy in use and apt to cause damage. Ratchet socket wrenches are used to be in engagement with hex head cap screws or nuts for the disassembly and assembly thereof, and have a ratchet structure preventing the reverse rotation of a transmission mechanism, keeping it rotated in a single direction upon the reciprocation of the wrench; in addition, the ratchet socket wrenches are labor-saving because lever principle is applied. Furthermore, soft drink or liquor is always packed by means of a glass bottle in combination with a metal bottle cap; conventional bottle openers are used to open the caps by means of lever principle.

However, conventional hexagonal wrenches, ratchet socket wrenches and bottle openers are very convenient in use, but the deficit is that they only have one single function; one tool having only one function without multi-use causes a waste of toolbox space and the heavy weight of a toolbox, resulting in inconvenience in transportation. Especially, vehicle toolboxes are preferably small in volume and light in weight so as to save space and fuel. In addition, a hexagonal wrench and ratchet socket wrench are always needed for the adjustment or repair of a bicycle upon bicycle sports, and a bottle opener is unavoidably needed for drinking beverage when going out to play, but, in the pursuit of effort and speed at the same time, carrying too many tools in the body is really inconvenient.

### SUMMARY OF THE INVENTION

The main object of the present invention is to provide a multifunctional wrench structure, capable of the disassembly and assembly of hexagonal head screws or nuts in a relaxed and labor-saving way through the designs of a ratchet member and rod body.

Another object of the present invention is to provide a multifunctional wrench structure, capable of the disassembly and assembly of hex socket cap screws through the design of a hexagonal member.

Still another object of the present invention is to provide a multifunctional wrench structure, capable of pulling a metal bottle out of a glass bottle in a relaxed and labor-saving way through the designs of a bottle opener member and rod body.

To achieve the objects mentioned above, the present invention proposes a multifunctional wrench structure, including a rod body, one end of which is configured with a ratchet member allowing the disassembly and assembly of hexagonal head screws (bolts) or nuts in a relaxed and labor-saving way by engaging the ratchet member with the hexagonal head screw or nut, and using the rod body by means of lever principle with the action of a ratchet structure; a hexagonal member is configured on one end of the rod body far away from the ratchet member allowing the disassembly and assembly of hex socket cap screws by inserting the hexagonal member in the hexagonal head screw to be in combination therewith; at least one bottle opener member is configured on the rod body between the ratchet member and hexagonal member, and a breach is formed on the bottle opener member, thereby allowing a bottle cap to be pulled out of a glass bottle only by engaging the bottle opener member in the metal bottle cap and oscillating the rod body by means of lever principle. The present invention can be used not only for the disassembly and assembly of hexagonal head screws, nuts and hex socket cap screws, but as a bottle opener, being light in carrying and convenient in use.

### BRIEF DESCRIPTION OF THE DRAWINGS

FIG. 1 is a perspective view of a preferred embodiment of the present invention;

FIG. 2 is a perspective view of the embodiment of the present invention viewing from another angle;

FIG. 3 is a top view of the embodiment of the present invention;

FIG. 4 is a right side view of the embodiment of the present invention;

FIG. 5 is a schematically perspective view of a ratchet member of the embodiment of the present invention in a use state;

FIG. 6 is a schematically perspective view of a hexagonal member of the embodiment of the present invention in a use state;

FIG. 7 is a schematically perspective view of a bottle opener member of the embodiment of the present invention in a use state; and

FIG. 8 is a schematically perspective view of the embodiment of the present invention in a use state, where an insertion element is in combination with a grip.

### DETAILED DESCRIPTION OF THE PREFERRED EMBODIMENTS

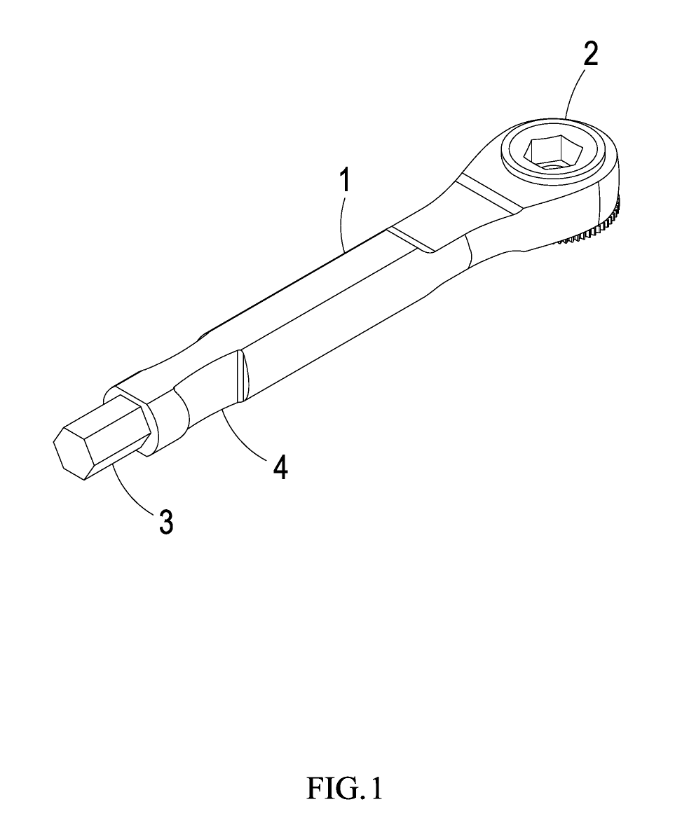

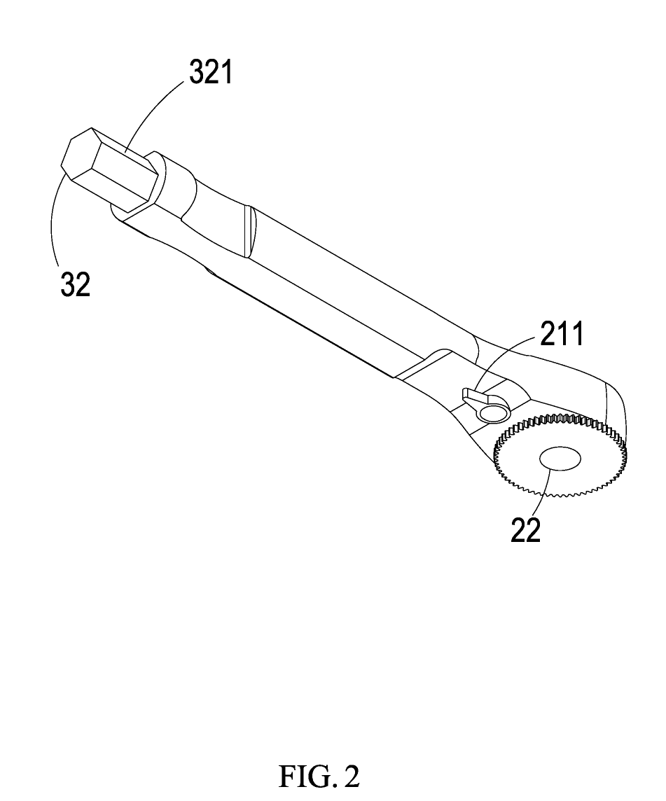

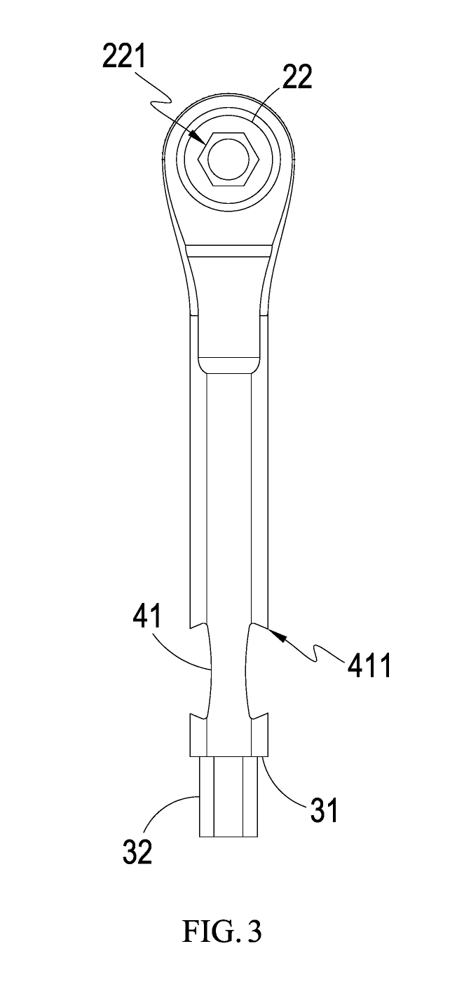

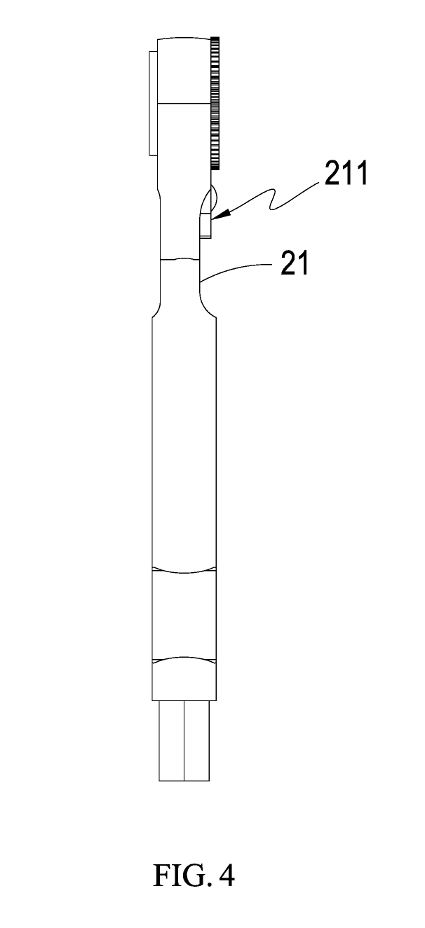

Referring to FIGS. 1 to 4, a multifunctional wrench structure of the present invention, in a preferred embodiment, includes: a rod body 1, one end of which being configured with a ratchet member 2, one side of which includes a groove 21 on which a selector element 211 is configured, and the ratchet member 2 including a through hole portion 22 formed with a plurality of engagement portions 221; a hexagonal member 3, configured on one end of the rod body 1 far away from the ratchet member 2, including a limit portion 21 and an insertion element 32 configured on one side of the limit portion 31 having a plurality of combination portions; and at least one bottle opener member 4, configured on the rod body 1 and positioned between the ratchet member 2 and hexagonal member 3, forming with a breach 41 on which at least on barb 411 is formed.

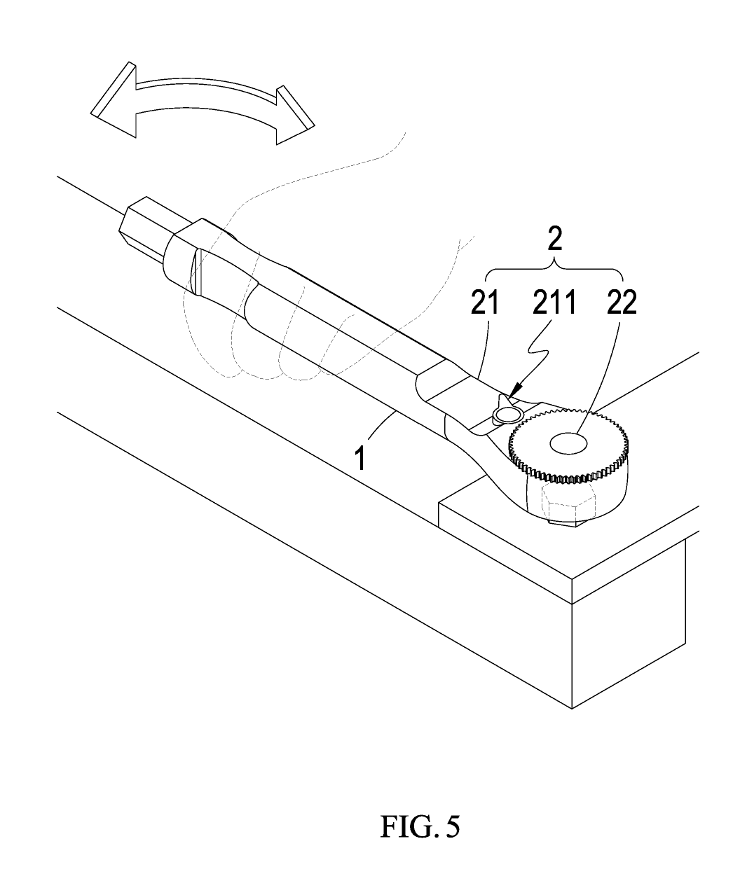

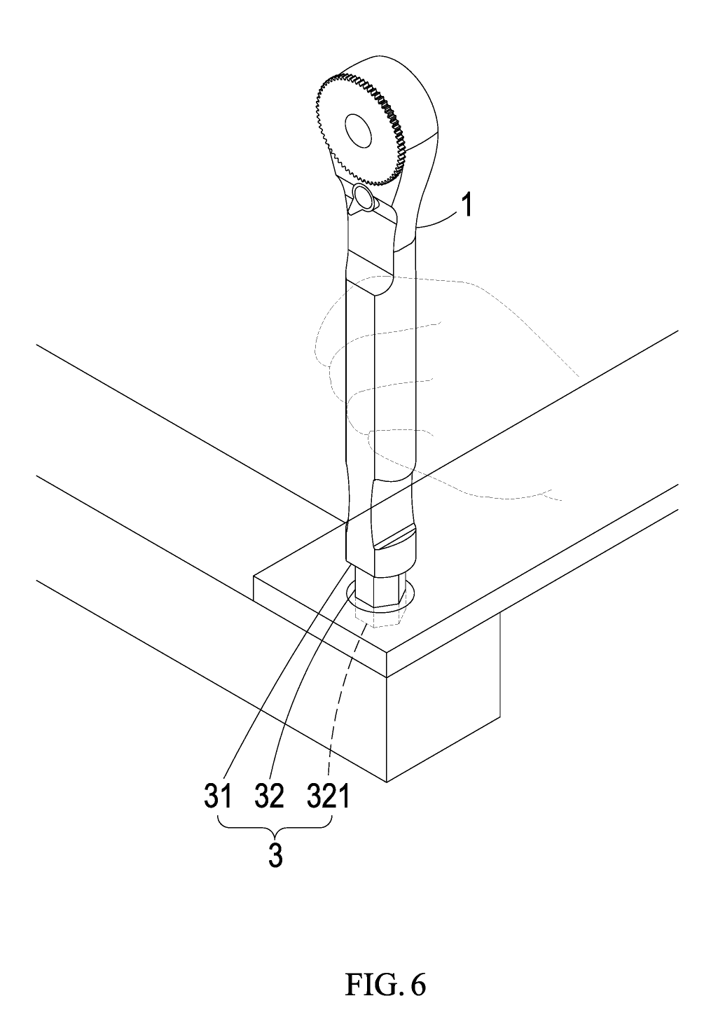

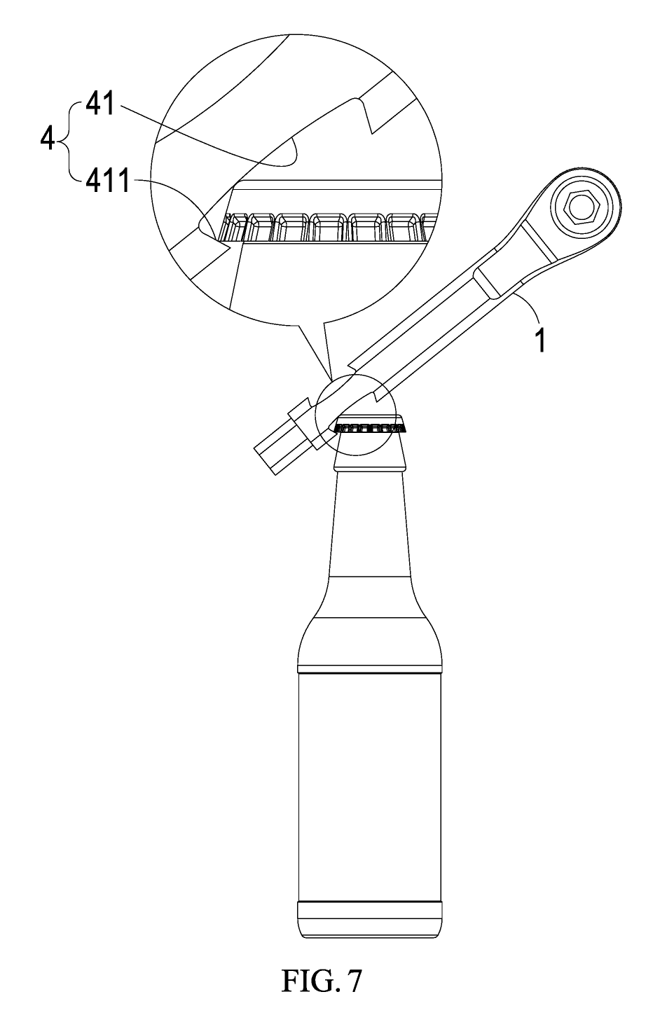

Referring to FIGS. 1 to 7, it can be seen clearly from the figures that when an hex head cap screw or nut wants to be disassembled or assembled, the through hole portion 22 of the ratchet member 2 may be put around the hex head cap screw or nut, and the engagement portions 221 will be in engagement with the screw or nut. Thereafter, the rod body is oscillated to drive the ratchet member 2 to rotate by means of lever principle, while the ratchet member 2 can still keep rotating in one single direction upon the reciprocation, where the selector element 21 is configured on one side of the rod body 1 far away from the engagement portions 221; the selector element 21 may be adjusted to select a direction in which the screw or nut can be rotated while placed on the ratchet member 2 when the screw or nut is engaged with the through hole portion 22, allowing the detachment or locking of the screw or nut to be convenient and labor-saving. Furthermore, the groove 21 allows the selector element 21 not to be compressed to damage easily when the rod body 1 is laid flat. Furthermore, the insertion element 32 of the hexagonal member 3 may be inserted into the hole of a hex socket cap screw when the screw wants to be detached, and the combination portion 321 will be in engagement with the hole of the screw so that the rod body 1 can be rotated to detach the screw. In addition the limit portion 31 can limit the insertion depth of the insertion element 32 in the hole, allowing the hexagonal member 3 to be more convenient in use.

In addition, a metal bottle cap on a glass bottle may be place on the breach 41 of the bottle opener member 4 when it wants to be removed from the bottle, the barb 411 is then hooked into one side of the cap, and the rod body 1 is oscillated to cause the barb 41 to pull the cap out of the bottle by means of lever principle.

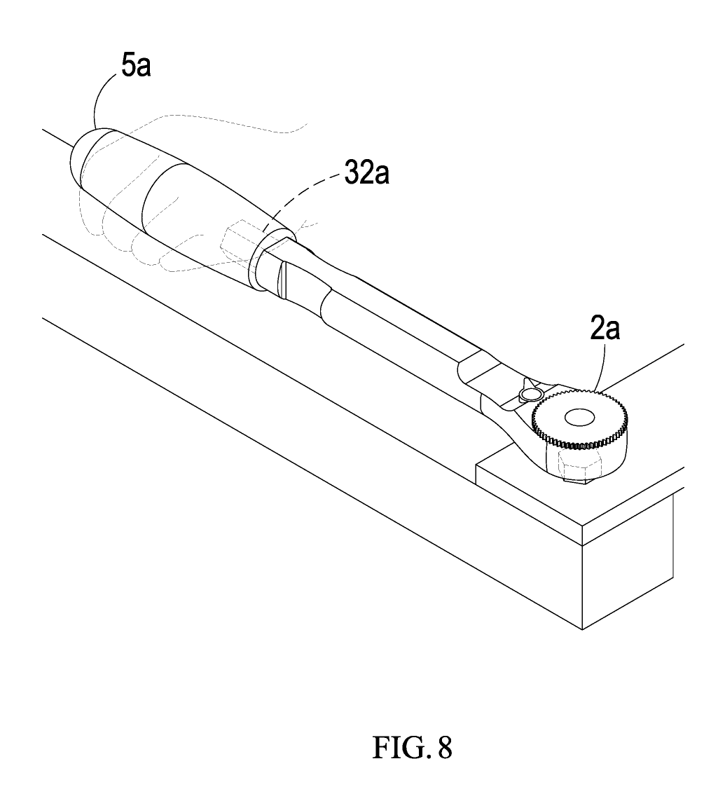

Referring to FIG. 8, it can be seen clearly that a grip 5a can be in combination with the insertion element 32a. A user can turn the ratchet member 2a conveniently by holding the grip 5a while using the rathet element 2a.

I claim:

1. A multifunctional wrench structure, comprising:
a rod body;
a ratchet member, configured on one end of said rod body;
a hexagonal member, configured on one end of said rod body far away from said ratchet member;
at least one bottle opener member, configured on said rod body and positioned between said ratchet member and hexagonal member; and
a breach, formed on said bottle opener member.

2. The structure according to claim 1, wherein a groove is configured on one side of said ratchet member.

3. The structure according to claim 2, wherein a selector element is configured on said groove.

4. The structure according to claim 1, wherein said ratchet member comprises a through hole portion.

5. The structure according to claim 4, wherein said through hole portion is formed with a plurality of engagement portions.

6. The structure according to claim 1, wherein said hexagonal member comprises a limit portion and an insertion element configured on one side of said limit portion.

7. The structure according to claim 6, wherein said insertion element is formed with a plurality of combination portions.

8. The structure according to claim 6, wherein a grip is capable of being in engagement with said insertion element.

9. The structure according to claim 1, wherein said breach is formed with at least one barb.
